(19) United States
(12) Patent Application Publication
(10) Pub. No.: US 2022/0081273 A1
(43) Pub. Date: Mar. 17, 2022

(54) CONTAINER CLOSING OR CAPPING DEVICE FOR CLOSING CONTAINERS, SUCH AS BEVERAGE BOTTLES OR SIMILAR CONTAINERS

(71) Applicant: Petra JOST, Ruedesheim (DE)

(72) Inventor: Petra JOST, Ruedesheim (DE)

(21) Appl. No.: 17/518,688

(22) Filed: Nov. 4, 2021

Related U.S. Application Data
(63) Continuation-in-part of application No. PCT/EP2020/061585, filed on Apr. 27, 2020.

(30) Foreign Application Priority Data
May 10, 2019 (DE) 102019112250.3

(51) Int. Cl. B67B 3/18

(52) U.S. Cl. CPC B67B 3/18

(57) ABSTRACT

A container closing or capping device for closing containers, such as beverage bottles or similar containers, includes at least one collecting device.

### CROSS-REFERENCE TO RELATED APPLICATIONS

The present application is a Continuation-in-Part of International Patent Application No. PCT/EP2020/061585, filed Apr. 27, 2020, which claims the benefit of Federal Republic of Germany Patent Application No. DE102019112250.3, filed May 10, 2019, each of which is incorporated by reference herein in its entirety.

### BACKGROUND INFORMATION

### 1. Technical Field

The present application relates to a container closing or capping device for closing containers, such as beverage bottles or similar containers.

Beverage bottle filling machines, or simply filling machines, are used in the beverage bottle filling or bottling industry to fill bottles with a liquid beverage. Such machines can be of a rotary or linear design. Rotary beverage bottle filling machines include a rotary carousel or rotor or similar structure that has a plurality of individual beverage bottle filling devices or beverage bottle filling stations mounted or positioned on the perimeter or periphery thereof. In operation, an individual beverage bottle is received or picked up from a bottle or container handling device or machine, such as another bottle treatment machine or a container transport or conveyor, which can be either of a rotary or linear design, and held at a corresponding individual filling device or station. While the rotary carousel rotates, each individual filling device or filling station dispenses a beverage, such as soft drinks and sodas, wine, beer, fruit juices, water, or other beverages, or another liquid product. Each individual filling device is usually designed to fill one beverage bottle or similar container at a time. Upon completion of filling, the beverage bottle or container is released or transferred to yet another bottle or container handling device or machine, such as another bottle treatment machine or transport device. The filling devices are therefore designed to fully dispense a predetermined or desired amount or volume of product into the beverage bottles or containers before the beverage bottles or containers reach the exit or transfer position out from the filling machine. The beverage bottle filling machine can also be of a linear design, wherein beverage bottles are moved to one or more filling positions along a straight or linear path.

Such filling machines are usually part of a filling or bottling plant, wherein the filling machine operates in conjunction with a number of other beverage bottle or container handling machines, such as a closing machine for placing caps or closures on filled containers, a container manufacturing machine for making or forming containers to be filled, and a container packaging machine for packaging individual containers for shipment and sale to consumers. Such plants are designed to operate as quickly and continuously as possible, and any interruptions in operation result in a loss of productivity and an increase in operating costs, especially since such plants can process large numbers of containers, such as, for example, anywhere from ten to seventy thousand containers per hour or possibly more.

The application further relates to a rotary-type closing device for closing containers, such as bottles, and to a closing element for such a closing device, and to a corresponding method for closing containers. In addition, the present application relates to a rotary-type closing device configured as a crown-cork closer or fitter.

### 2. Background Art

This section is for informational purposes only and does not necessarily admit that any publications discussed or referred to herein, if any, are prior art.

Container processing machines in the form of closing devices for the closing of containers are widely utilized in the beverage bottling or container filling or production industry, and are also designated as container closing machines or closers. Such closers are used, for example, in beverage filling systems, and are often arranged in the immediate spatial proximity of a corresponding filling station or filling machine, in direct connection with them, such that the freshly or recently filled containers can be closed immediately or soon after they are filled.

Closing devices of the type referred to can be configured in this situation for the closing of bottles or other containers with screw closures or as what are referred to as crown-cork fitters of bottles with suitable crown corks. The closures can include screw-top closures, screw caps, caps, crown corks, crown caps, press-on closures, seals, lids, and other types of closures used to close bottles, cans, jars, or similar container.

One type of closing device is a rotary closing device that has a plurality of container closing positions formed at the circumference of a rotor, which is driven such as to circulate about a vertical machine axis or middle axis. In this situation, assigned to each container closing position is a closing element, which is also to be understood as a closing tool or as a closing punch.

In this situation, the closing elements or closing tools of such closing devices can be moved along a vertical closing element axis in an axial lifting movement between a raised and a lowered position, wherein this axial lifting movement is also understood as a placement lifting movement. This placement lifting movement is usually produced by lifting cams, which are provided for controlling the height of the closing elements. In other words, the lifting cams control the extent or range of the reciprocating movement of the closing element in a vertical direction up and down.

With a corresponding height control method by use of lifting cams, the closing elements are forcibly guided so as to circulate in the lifting cam, wherein the closing elements comprise for this purpose conventionally connected rollers or running rollers, which are forcibly guided as they run on or against a guide surface of the lifting cam. With such a forcibly-guided arrangement controlled by lifting cams, lubrication or roller lubrication is applied in the region of the rollers and/or of the guide surface of the lifting cam, such as by an application of lubricant, wherein the application of the lubricant may be performed by an automated lubricant delivery arrangement.

However, in the course of the operation of such a closing device, the lubricant can be compressed with time and may form clumps or fall out. The lubricant material which is compressed or formed into clumps then emerges from the lifting cam and falls downwardly. This is problematic with closing devices of which the closing elements are provided at an upper end with the running rollers and which are therefore forcibly guided on the upper side in the lifting cam, since in these cases the clumped or escaping lubricant material falls onto the containers which are being guided or held underneath. A substantial disadvantage is therefore incurred if the running rollers and the lifting cam are arranged above the container mouths of the filled containers which are to be closed, as falling lubricant can then lead to contamination in the mouth area of the containers.

In other words, in some closing devices or closing machines, a cam roller arrangement is used to control the reciprocating or up-and-down movement of a closing element designed to hold and apply closures to containers. A stationary guide structure defines a guide path that at least partially surrounds or borders or encloses a movable roller structure. As the roller structure is moved within the guide structure, the roller contacts the side walls or guide wall surfaces of the guide structure. The guide walls have a curved or undulating profile to deflect the roller and move it up and down as the roller travels along the guide wall. The roller is attached or connected to the top or an upper portion of a closing element, so as the roller is moved up and down, the closing element is also moved up and down in a reciprocating motion. To facilitate the rolling motion or movement of the roller structure and minimize wear and tear or damage due to contact between the roller structure and the guide structure, a lubricating material or lubricant is applied to the roller structure and/or the guide structure. During operation of the closing machine, the lubricant can be compressed or squeezed or smashed between the roller structure and the guide structure, and thus portions or clumps or pieces of lubricant can be pressed or squeezed our from between the roller structure and the guide structure, which portions or clumps or pieces of lubricant can then fall downwardly due to gravity. Unfortunately, the closing portion of the closing element that holds and applies the closures to the containers is located at the lower end of the closing element opposite the upper or top end where the roller structure is located. Consequently, falling lubricant can land on and adhere or become stuck to the closing portion, thereby contaminating the closing portion with lubricant. The lubricant can then be inadvertently applied to a closure or a container, and possibly be introduced into the interior of the container. In either instance, the container and/or the product inside can be contaminated, thereby rendering the container and/or the product unsuitable for sale and/or consumption by consumers. In addition, falling lubricant could also fall directly into the containers while the container is open prior to application of a closure, thereby causing direct contamination of the product in the container.

An object of the present application is therefore to provide a closing device for closing containers with closing elements which are controlled by lifting cams, with which, in a relatively simple structural manner, the penetration of lubricant into the hygiene region of the closing elements, as well as penetration into the bottle treatment area, is minimized or avoided.

### SUMMARY

To solve this object, a closing device for closing containers is configured in accordance with at least one possible exemplary embodiment disclosed herein, and a closing element is configured in accordance with at least one possible exemplary embodiment disclosed herein. A method for closing containers in accordance with at least one possible exemplary embodiment is also disclosed herein. At least one further possible exemplary embodiment is described herein. In this situation, all the features described are in principle the object of the application, taken alone or in any desired combination, regardless of their relationships or combinations disclosed herein.

According to a first aspect, the present application relates to a closing device of the rotary type for closing containers, wherein the closing device comprises a plurality of container closing positions, in each case with at least one closing element, arranged at the circumference of a rotor driven by a motor such as to rotate about a vertical middle axis of the closing device. In this situation, the closing elements for controlling the height are forcibly-guided or positively guided by a lifting cam such as to circulate about the middle axis. According to at least one possible exemplary embodiment, in this situation provision is made for at least one shell-shaped collecting device to be arranged on at least one of the plurality of closing elements. The at least one collecting device is configured such as to catch lubricant that is used on the lifting cams in order to improve the rolling movement of rollers. The at least one collecting device, with at least one securing section, is provided or arranged or disposed at least partially circumferentially at at least one outer circumference of the at least one closing element, as well as provided or arranged or disposed underneath the rollers.

A lifting cam in the context of this application is a conventional lifting cam commonly used in the bottling or container filling industry. In this situation, as a guide surface for the forcible guidance, a guide groove can be provided for at least partially receiving the rollers of the closing elements. Likewise, the lifting cam can comprise an essentially L-shaped cross-section, wherein the horizontally oriented limb forms or provides the guide or support surface. The outer circumference of the closing element is accordingly understood to be the outer circumference surface, i.e., the outer casing surface of the closing element. The outer circumference therefore forms the outer diameter of the closing element.

According to at least one possible exemplary embodiment, provision can be made in this situation for the shell-shaped collecting device or structure to comprise a base surface and side surfaces, which surround the base surface at its edges, such that a shell-shaped catchment space or basin for the lubricant is formed inside the base surface, delimited at its sides by the side surfaces.

According to at least one possible exemplary embodiment, provision can be made in this situation that the base surface with its associated side surfaces is configured as of one unit, such as one piece, and is made of a plastic, such as a polyamide, or a metallic material, such as special steel. However, most any hard or stiff material that is generally resistant to wear and contamination could be suitable to be used to form the collecting structure.

According to at least one possible exemplary embodiment, provision can be made in this situation for a plurality of closing elements, and possibly all the closing elements, to be equipped with at least one collecting device, wherein the closing elements equipped with the collecting devices are assigned to respective container closing positions, which are arranged uniformly distributed over the circumference of the rotor.

According to at least one possible exemplary embodiment, provision can be made in this situation for at least one closing element to comprise a plurality of collecting devices offset along the axis of the closing element and arranged at a distance interval from one another.

According to at least one possible exemplary embodiment, provision can be made in this situation for the plurality of closing devices to be configured in each case as identical to one another.

According to at least one possible exemplary embodiment, provision can be made in this situation for the at least one collecting device to comprise a securing section, which is formed as a passage opening in the base surface which is matched in its entire circumference to the outer circumference of the assigned closing element.

According to at least one possible exemplary embodiment, provision can be made in this situation for the securing section to be configured as a circular passage opening, matched in its entire circumference to the outer circumference of the collecting device, and which encloses the outer circumference in contact fit, such as in a non-positive or positive fit, in such a way that the collecting device is held in a fixed or essentially fixed position at the closing element.

According to at least one possible exemplary embodiment, provision can be made in this situation for the securing section to comprise at its circular free edge section, facing towards the associated closing element axis, at least over part of the circumference, a sealing element, or, alternatively, is made of a sealing material.

According to at least one possible exemplary embodiment, provision can be made in this situation for the at least one collecting device to comprise two securing sections, which in each case are provided, or possibly arranged, in each case over part of the respective outer circumference between two adjacent closing elements, as well as beneath the rollers.

According to at least one possible exemplary embodiment, provision can be made in this situation for the two securing sections to be formed at two opposing side surfaces of the collecting device, wherein these two side surfaces are matched, at least in one part section, to the outer circumference of the closing element.

According to at least one possible exemplary embodiment, provision can be made in this situation for the collecting device to comprise a gripping element on the side surface facing away from the machine axis.

According to at least one possible exemplary embodiment, provision can be made in this situation for the side surfaces, configured as the two securing sections, to form, at least in sections, in each case a partially circular securing section, by which the collecting device is held between the respective outer circumferences of two adjacent closing elements, in each case fixed in position between the adjacent closing elements over part of the circumference, in contact fit, such as in non-positive and/or positive fit.

According to at least one possible exemplary embodiment, provision can be made in this situation for at least one collecting device to be provided between several adjacent closing elements, possibly between all the adjacent closing elements, wherein the closing elements equipped with the collecting devices are assigned to respective container closing positions, which are arranged distributed uniformly over the circumference of the rotor.

According to at least one possible exemplary embodiment, the closing device is a crown cork fitting device.

In accordance with at least one possible exemplary embodiment, the present application discloses a closing element for a rotary-type closing device for closing containers, which closing device comprises a plurality of container closing positions, arranged at the circumference of a rotor, driven by a motor such as to rotate about a vertical middle axis, and a lifting cam for controlling the height of the closing elements. According to at least one possible exemplary embodiment, provision is made in this situation for at least one shell-shaped collecting device to be provided at the closing element, which is configured so as to catch lubricant used on the lifting cam for the sliding running of the rollers, in that the at least one collecting device, with at least one securing section, is provided, or possibly arranged, at least partially circumferentially on at least one outer circumference of the at least one closing element, as well as beneath the rollers.

At least one possible exemplary embodiment of the present application also relates to a method for closing containers, with which the containers are closed with closure covers, such as by use of a rotary-type closing device, comprising at the circumference a plurality of container closing positions arranged at the circumference of a rotor, driven by a motor such as to rotate about a vertical middle axis, with in each case at least one closing element, and further comprising a lifting cam for controlling the height of the closing elements. According to at least one possible exemplary embodiment, provision is made in this situation that at least one shell-shaped collecting device is provided on at least one of the plurality of closing elements, by which the lubricant is caught which is used on the lifting cam for the rolling movement of rollers, in that the at least one collecting device is provided with at least one securing section, at least partially circumferentially, on at least one outer circumference of the at least one closing element, as well as beneath the rollers.

The expression “essentially” or “approximately” signifies in the meaning of the invention deviations from the respective exact value by +/−10%, preferably by +/−5%, and/or deviations in the form of changes which are not of significance for the function.

It should be noted that a positive fit or positive force or positive guidance, in the context of this application, refers to a situation in which at least two components engage in a form fit, that is, at least a portion of an outer edge or boundary or surface of a first component substantially or essentially conforms to or fits within a corresponding portion of an inner edge or boundary or surface of a second component. This form fit between the two components results in the first component being retained against movement or displacement out of engagement with the second component. A common type of positive fit is when a first component is bound on at least one side or portion by a retaining structure, such as a side wall or guide surface, of a second component, such that, when a force is applied to move the first component in the direction of and against the retaining structure of the second component, the retaining structure resists movement or displacement of the first component, that is, the retaining structure acts like a wall or similar to block the movement. Male and female components that are connected by tabs or shoulders are another example of a positive or form fit. A positive guidance can occur when the first component is movable and the second component is a guide structure, wherein as the first component is moved into contact with the second component, the first component is deflected or guided along the path of movement defined or bounded by the second component. Again, the movement or displacement of the first component in a certain direction is resisted or blocked by the guide wall or surface of the second component, such that the first component is physically deflected or guided by the second component in a different direction or path of movement.

It should also be noted that a non-positive fit or non-positive force or non-positive guidance, in the context of this application, refers to a situation in which at least two components engage in a friction fit, that is, at least a portion of an edge or boundary or surface of a first component is in frictional engagement or contact with a corresponding portion of an edge or boundary or surface of a second component. This friction fit between the two components results in the first component being retained by friction against a sliding or translating movement or displacement with respect to the second component. A common type of non-positive fit is when a surface portion of the first component is positioned in contact with a corresponding or matching surface portion of the second component, such that, when a force is applied to move the first component along or across the surface portion of the second component, the friction between the surfaces at least resists movement or displacement of the first component, and prevents movement if the friction force is greater than the movement force. It is not uncommon for two components to engage in both a positive fit due to at least a partially matching or corresponding structural design that forms a retaining surface, and a non-positive fit due to frictional forces between surfaces of the components that are in frictional contact with one another. In such a situation, the positive fit and non-positive combine to produce a greater retaining or resisting force than would be generated or provided by one or the other alone.

Further embodiments, advantages, and possible applications of at least one possible exemplary embodiment of the application are also derived from the following description of exemplary embodiments and from the figures. In this situation, all the features described and/or represented as images can be used in at least one possible exemplary embodiment to solve at least one object disclosed herein, individually or in any desired combination, regardless of their arrangement in the embodiments disclosed herein.

Although some aspects have been described in connection with a device, it is understood that these aspects also represent a description of the corresponding method, such that a block element or a structural element of a device is also to be understood as a corresponding method step or as a feature of a method step. By analogy with this, aspects which have been described in connection with or as a method step also represent a description of a corresponding block or detail or feature of a corresponding device. Some or all of the method steps can be carried out by a hardware apparatus (or by making use of a hardware apparatus), such as, for example, a microprocessor, a programmable computer, or an electronic circuit. With some exemplary embodiments, some or many of the most important method steps can be carried out by such an apparatus.

### BRIEF DESCRIPTION OF THE DRAWINGS

FIG. 1A shows a schematic top view of a container handling or beverage bottling machine in accordance with at least one possible exemplary embodiment;

FIG. 1 shows a schematic side and/or cross-sectional view of at least one possible exemplary embodiment of a closing device;

FIG. 2 shows a schematic perspective view of a collecting device disposed on a portion of a closing element in accordance with at least one possible exemplary embodiment;

FIG. 3 shows a schematic view from above of a plurality of collecting devices, which are the same or similar to the collecting device shown in FIG. 2, disposed about a central machine axis, in accordance with at least one possible exemplary embodiment;

FIG. 4 shows a perspective view of a collecting device in accordance with at least one possible exemplary embodiment;

FIG. 5 shows a schematic view from above of a plurality of collecting devices, which are the same as or similar to the collecting device shown in FIG. 4, disposed about a central machine axis, in accordance with at least one possible exemplary embodiment;

FIG. 6 shows a schematic diagram representative of a portion of a cam roller arrangement in accordance with at least one possible exemplary embodiment; and

FIG. 7 shows a schematic diagram of a closing device with more than one collecting device in accordance with at least one possible exemplary embodiment.

### DETAILED DESCRIPTION

Identical reference numbers are used in the figures for elements of the invention which are the same or have the same effect. Further, for the sake of easier overview, only reference numbers are shown in the individual figures which are required for the description of the respective figure. At least one possible exemplary embodiment is also represented in the figures only as a schematic view to explain the working method. The representations in the figures serve only to explain the basic principle of at least one possible exemplary embodiment. For reasons of easier overview, the representation of some of the constituent parts of the device have been omitted.

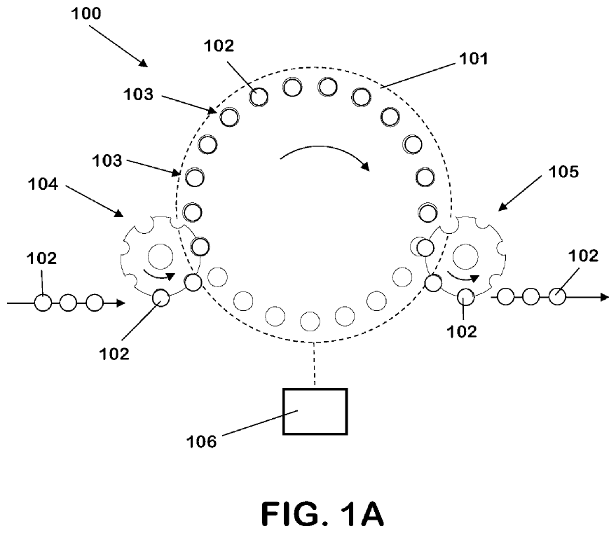

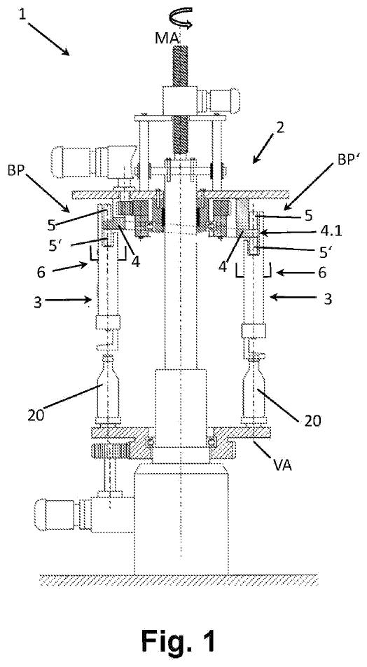

FIG. 1A shows a schematic top view of a container handling or beverage bottling machine 100 for handling containers 102, such as bottles, cans, kegs, or similar containers, in accordance with at least one possible exemplary embodiment. The container handling machine 100 comprises a rotor or carousel 101 designed to rotate about a vertical axis of rotation. A plurality of container handling arrangements 103 are disposed about the periphery of the rotor 101. The container handling arrangements 103 can be designed to perform different functions depending on the container handling machine 100, such as container filling, closing, labeling, and other such container handling functions. A first rotary container transport device 104, such as a star wheel or similar device, moves containers 102 into the container handling arrangements 103. A second rotary container output device 105, such as a star wheel or similar device, moves containers 102 out of the container handling arrangements 103. A control arrangement 106, such as a computer control arrangement, is operatively connected to the container handling machine 100 to control and/or monitor the operation of the container handling machine 100 and the components thereof.

The closing device represented by 1 in FIG. 1 is a rotary-type closing machine for closing the containers 20, such as bottles or the like, with a crown cork, which closing machine 1 is therefore also designated as a crown-cork fitter.

Represented in FIG. 1, only by way of example, is at least one possible exemplary embodiment of a closing machine 1, wherein, for reasons of easier overview, only some of the components of the whole closing machine 1 are explicitly explained, namely components which are relevant for the description of the embodiment shown, and for this purpose are provided with reference numbers in FIG. 1. For reasons of easier overview, no more detailed explanations are provided here with regard to other components and elements of the closing machine 1 which are not of particular significance in connection with embodiment shown.

Usually, with such a closing machine 1, a filling machine, not represented in greater detail in the figures, is arranged in spatial proximity upstream in a transport direction, for the filling of the containers 20 with a liquid filling product. The containers 20 filled by the filling machine are conveyed by transport devices, such as conveyor belts, to the closing machine 1, and there, on the inlet side, are transferred from a transfer element, likewise not represented in any greater detail, such as an inlet star, to the actual closing machine 1. After running through the closing machine 1, i.e., after the closing of the individual containers 20 with a crown cork, the containers 20 closed in this way are taken over on the outlet side of the closing machine 1 by a further transfer element, such as an outlet star, provided following the closing machine 1 in the transport direction, and are transported away in a manner known to the person skilled in the art. For reasons of easier overview, the delivery and provision of the individual closures, such as crown corks or caps, to the closing machine 1 is not represented in FIG. 1, since this can likewise be carried out using delivery mechanisms suitable for such closing machines commonly used in the beverage bottling or container filling industry.

The closing device 1 comprises a fixed-position central column, extending along a vertical middle axis MA, provided on which is at least one rotor 2, driven by a motor such as to circulate, and which, driven by the motor, rotates circulating in a direction of rotation indicated by a rounded arrow. Arranged at the circumference of the rotor 2 are a plurality of container closing positions BP, BP′, of which, for reasons of easier overview, only two are represented in

FIG. 1.

Each container closing position BP, BP′ comprises in each case at least one closing element 3, which extends, according to its length, along the closing element axis VA, in each case oriented vertically. When the rotor 2 circulates, the closing elements 3 can be lifted in an axial lifting movement between a raised and a lowered position, namely up and down in the vertical direction. The closing element 3 of the container closing position BP represented in FIG. 1 assumes the raised position, and that of the container closing position BP′ represented in FIG. 1 is in the lowered position. The axial lifting movement is also understood to be an adjusting lifting movement, and forms a height control mechanism for the closing elements 3, that is, the vertical position or height to which the closing elements 3 can move up or down.

For this height control, a lifting cam 4 is provided, by which the closing elements 3 are forcibly guided to circulate about the middle axis MA. For this purpose, the closing elements are provided on the upper side or upper end with a roller 5, which runs guided on a guide surface 4a of the lifting cam 4. The roller 5 therefore, by way of its running surface 5a, interacts with the guide surface 4a of the lifting cam 4, which in the meaning of the present application can be understood as the running of the roller 5 along on the guide surface 4a of the lifting cam 4, but also as the rolling of the roller 5 along the guide surface 4a of the lifting cam 4.

Since what is referred to as dry-running, that is, running without lubricant, of the rollers 5 on the lifting cam 4 cannot be achieved, or at least not practically performed, at the present time, lubrication is provided in order to make the running of the roller 5 easier, such as by the application of lubricant, such as lubricating grease, in the region of the lifting cam 4 and the roller 5. In the present case, the terms roller lubrication or lubricant application can be used synonymously with the term lubrication. The axial lifting movement of the closing elements 3 along the closing element axis VA for their height adjustment takes place during the circulation of the closing elements 3 about the middle axis MA due to the forcible guiding of the roller 5 in the lifting cam 4, and in the present case is therefore designated as a lifting cam-controlled height adjustment or as a lifting cam height control.

The lifting cam 4 of the exemplary closing device 1 exhibits an essentially L-shaped cross-section with a horizontal and a vertical limb, wherein the horizontally-oriented limb forms or provides the guide surface 4a. Over the circumference of the lifting cam 4, the vertical extension varies, in particular a length of the vertical limb, which in the container closing position BP represented exhibits the shortest length, and in the container closing position BP′ exhibits the greatest length. An outer circumference 4.1 of the lifting cam 4 is defined by the approximately vertically-oriented face surface of the horizontally oriented limb, which also forms the outer circumferential surface, in this example lying on the outside, and therefore determines the outer diameter of the lifting cam 4.

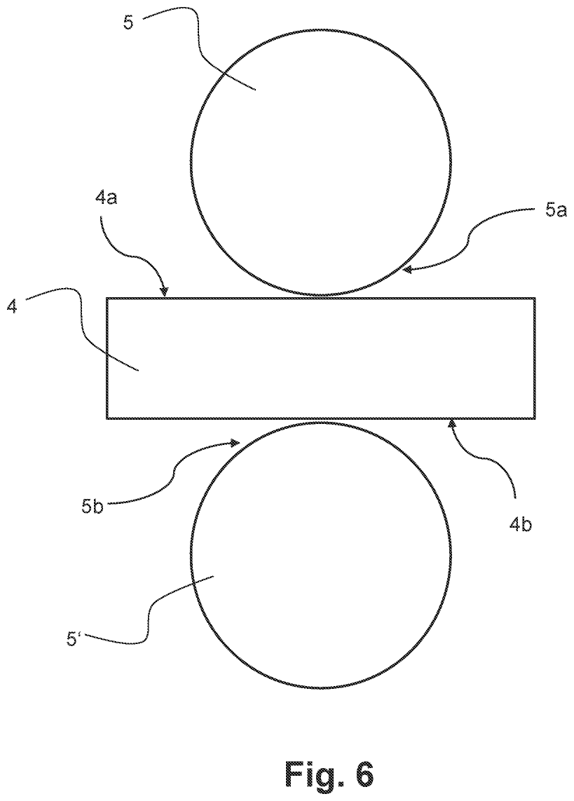

In the example represented in FIG. 1, next to the roller 5 at the closing element 3, a further roller 5′ is provided, which lies opposite the roller 5 in relation to the guide surface 4a of the lifting cam 4, and engages on the under side 4b with the horizontal limb of the lifting cam 4 with its roller surface 5b, as shown in greater detail in a schematic diagram in FIG. 6.

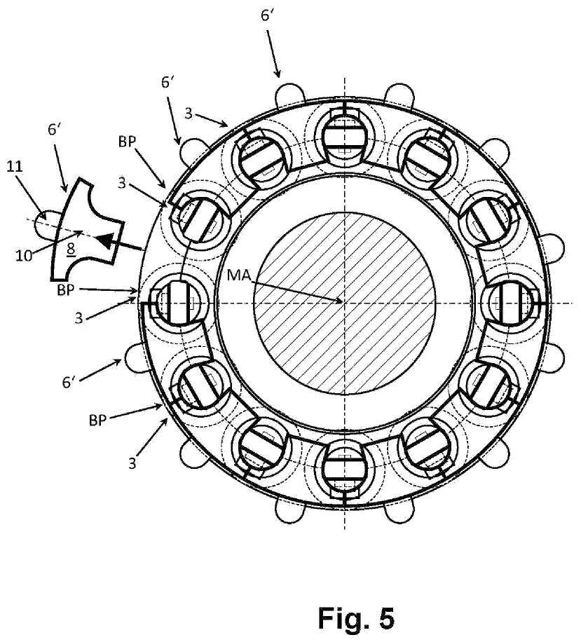

In order to avoid the lubricant used for lubrication falling out of the region of the lifting cam 4, and therefore passing into the hygiene area of the closing device 1, namely into the area of the containers 20 being guided past underneath the closing elements 3, in particular the area of the container mouth of these containers 20, with the present closing device 1 a shell-shaped collecting device 6 is provided at least at one of the closing elements 3 of the container closing positions BP, BP′. It should be noted that while FIG. 1 shows collecting device 6 installed in the closing machine 1, collecting device 6′ can alternatively be installed in such a closing machine 1, as shown in FIG. 5.

In greater detail, provision is made in this situation that the shell-shaped collecting device 6, provided at least at one of the plurality of closing elements 3, is configured such as to catch a lubricating agent used on the lifting cam 4 for the rolling running of the rollers 5, 5′, in that the at least one collecting device 6, with at least one securing section 7, is provided or arranged, at least partially circumferentially at an outer circumference 3.1 of the at least one closing element 3, as well as underneath the rollers 5, 5′.

In accordance with at least one possible exemplary embodiment, the outer circumference 3.1 of the closing element 3 is understood to be the outer circumferential surface, i.e., the outer casing surface of the closing element 3, such that the outer circumference 3.1 therefore forms the outer diameter of the closing element 3, or corresponds to the outer diameter.

The shell-shaped collecting device 6 exhibits in this situation an essentially flat or planar base surface 8, as well as side surfaces 9, surrounding the base surface 8 on the edge sides, such that, inside the base surface 8, a shell-shaped catchment space 10 or basin or trough or container for the lubricant is formed which is delimited on the sides by the side surfaces 9.

In this situation, the plurality of side surfaces 9 form wall surfaces, which with their free edge sections, i.e., those not in connection with the base surface 8, point essentially in the direction of the rollers 5, 5′.

In this situation, likewise, the base surface 8 can span a plane E, which is oriented perpendicular or essentially perpendicular to the respective closing element axis VA of the corresponding closing element 3. In at least one possible exemplary embodiment, the side surfaces 9 enclose with the plane E, running in the base surface 8, an obtuse angle of less than 120 degrees, or possibly an angle of between 90 degrees and 95 degrees. In this situation, the base surface 8, as viewed from above, is essentially configured as trapezoidal in shape or having a tapered or pie piece or wedge design in which the outer portion is larger than the inner portion.

In accordance with at least one possible exemplary embodiment, the base surface 8 of the collecting device 6 is produced as one unit with the associated side surfaces 9, such as in one piece or in a unitary or integral manner, and is made of a plastic, such as a polyamide, or a metallic material, such as a special steel. Accordingly, simple and hygienic cleaning of the falling lubricant from the respective collecting device 6 is possible.

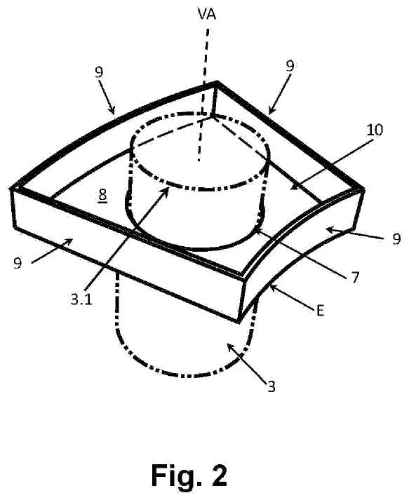

Further, the at least one collecting device 6 is provided or arranged or disposed with at least one securing section 7, at least partially circumferentially, and at least at one outer circumference 3.1 of the at least one closing element 3, as well as underneath the rollers 5, 5′. In the embodiment variant from FIG. 2, the securing section 7 is configured as a passage opening through the base surface 8, matched in its full circumference to the outer circumference 3.1 of the at least one closing element 3. The securing section 7 is in this situation configured as a circular passage opening matched to the outer circumference 3.1, which surrounds the outer circumference 3.1 in its full circumference in contact fit, such as in a non-positive or positive fit, in such a way that the collecting device 8 is held in a fixed position, i.e., is spatially secured, at the closing element 3. The collecting device 6 is therefore configured so as to be exchangeable at the outer circumference 3.1 of the closing element 3, and, during a dismantling of the closing element 3 for cleaning or emptying purposes, can be easily drawn upwards or downwards axially to the closing element axis VA. This also makes it possible, during maintenance work, to carry out subsequent equipping work or retrofitting on closing devices 1 which are already installed and in place.

In accordance with at least one possible exemplary embodiment, provision can also be made in this situation for the securing section 7 to comprise at its circular free edge section, facing towards the closing element axis VA, at least over part of its circumference, a sealing element, for example in the form of a circumferential sealing lip, or, as an alternative, made of a sealing material, for example of an elastically deformable plastic.

In accordance with at least one possible exemplary embodiment, however, provision is made for the securing section 7 to comprise at its circular free edge section, facing towards the closing element axis VA, over the full circumference, a sealing element, for example in the form of a circumferential sealing lip, or, as an alternative, is made of a sealing material, such as an elastically deformable plastic. It is therefore ensured that no lubricant, or at least a minimal amount of lubricant, can pass over the securing section 7 in the direction of the hygiene area or the mouth area, i.e., run downwards at the outer circumference 3.1 of the closing element 3.

In at least one possible exemplary embodiment, provision can further be made in this situation for a plurality of closing elements 3, or possibly all the closing elements 3, to comprise in each case at least one collecting device 6, wherein the closing elements 3 equipped with the collecting devices 6 are assigned to respective container closing positions BP, BP′, which are arranged distributed uniformly over the circumference of the rotor 2.

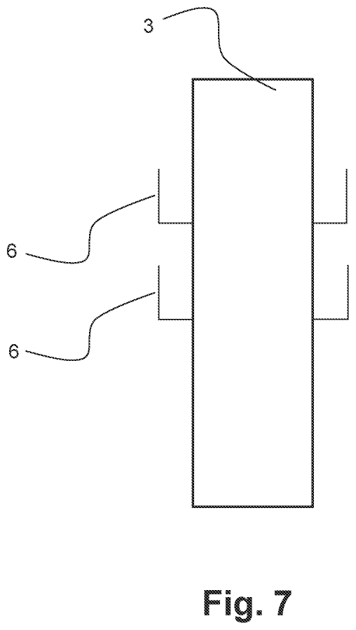

In this situation, provision can also be made for the at least one closing element 3 to comprise several, possibly two, collecting devices 6, offset along the closing element axis VA and arranged at a distance interval from one another. In other words, according to this embodiment variant, an upper collecting device 6 is therefore provided, as well as a collecting device on the closing device 3 further down in relation to the closing element axis VA. FIG. 7 shows a schematic diagram of a closing device 3 with more than one collecting device 6 in accordance with at least one possible exemplary embodiment.

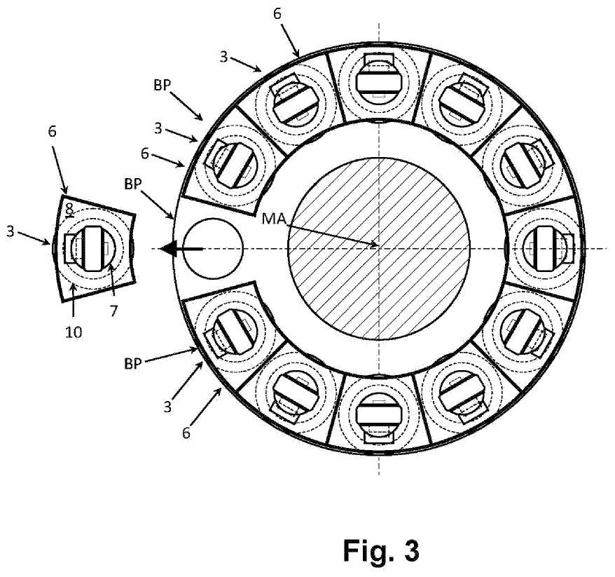

In at least one possible exemplary embodiment, the plurality of collecting devices 6 are in each case configured as identical to one another. As can be seen from FIG. 3, the plurality of identically designed collecting devices 6 can be provided in an essentially circular ring form around the central middle axis MA, as well as being in contact connection among one another located on the respective closing element 3. In this connection, the collecting devices 6 can be provided essentially in a common plane or such that the planes E are coplanar.

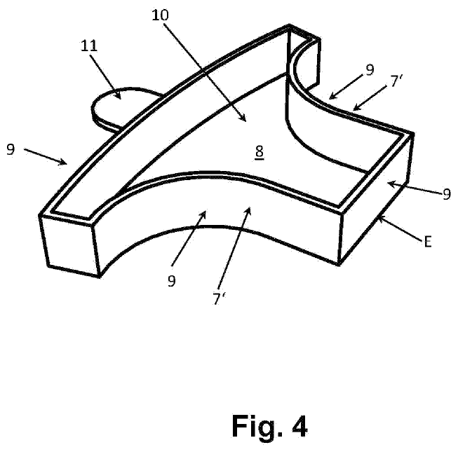

In this situation, FIGS. 4 and 5 show a further embodiment variant of the collecting device 6′, which are provided or arranged or disposed with at least one securing section 7′, at least partially circumferentially at an outer circumference 3.1 of the at least one closing element 3 as well as underneath the rollers 5, 5′. In greater detail, the embodiment variant from FIGS. 4 and 5 comprise in this situation two securing sections 7′, which in each case are provided or arranged partially circumferentially at the respective outer circumference 3.1, between two adjacent closing elements 3, as well as beneath the rollers 5, 5′.

In at least one possible exemplary embodiment, the securing sections 7′ are formed on two opposing side surfaces 9 of the collecting device 6′. In greater detail, in this situation the securing sections 7′, configured as side surfaces 9, are matched in at least one part section to the outer circumference 3.1 of the closing element 3.

In at least one possible exemplary embodiment, the opposing securing sections 7′, provided as side surfaces 9, form for this purpose, at least in sections, in each case a partially circular securing section 7′, by which the collecting device 6′ is held in a fixed position between the respective outer circumferences 3.1 of two adjacent closing elements 3, in each case partially circumferentially as well as in contact fit, such as in non-positive and/or positive fit, i.e., spatially secured between the adjacent closing elements 3. In other words, the collecting devices 6′ are wedged in between two adjacent closing elements 3, wherein the shape of the securing sections 7′ follows the or matches the shape of the closing elements 3 to create a frictional engagement and/or a form fit engagement to keep the collecting devices 6′ in the position where they are installed.

Accordingly, the collecting device 6′ is configured as being exchangeable at the outer circumference 3.1 of the closing element 3, and, during a disassembly of the closing element 3 for cleaning or emptying purposes, can be easily pushed between the respective outer circumferences 3.1 of two adjacent closing elements 3 and also drawn out again. This also makes possible the simple subsequent equipping or retrofitting of closing devices 1 which are already installed and in place, during maintenance work.

For this purpose, the collecting device 6′ can comprise, at the side surface 9 facing away from the machine axis MA, a gripping element 11, for example in the form of a retaining tab.

In at least one possible exemplary embodiment, provision can be further made in this situation that in each case at least one collecting device 6′ is provided between several adjacent closing elements 3, or possibly between all the adjacent closing elements 3, wherein the closing elements 3 equipped with the collecting devices 6′ are assigned to respective container closing positions BP. BP′, which are arranged uniformly distributed over the circumference of the rotor 2.

The foregoing example relates to a closing device 1 configured as a crown-cork fitter. However, the embodiments disclosed herein are suitable for use in or with a closing device 1 for closing containers 20 with essentially any type of container closure, such as screw closures, screw caps, and plastic screw tops. With such mechanical plastic screw tops, the lubricating situation of the running surfaces 5a of the rollers 5, 5′ of a closing element 3 on the lifting cam 4 is similar to that of the crown-cork fitter, except that, with plastic screw tops of the type referred to, there is definitely less loading or physical stresses on the rollers than with the crown-cork fitter. The collecting device 6 described heretofore can therefore likewise be used with a plastic screw top.

In operation of the closing machine 1, by using the collecting device 6 described, lubricant which drips downwards or runs down along the outer circumference 3.1 of the closing element 3, such as grease, is caught to the greatest possible extent, or at least to a desired or predetermined or optimal level, as a result of which the grease is prevented from falling into the hygiene area of the container mouths of the containers 20 running past under the respective closing element 3. Accessibility for possible routine manual cleaning action above the carrying plate of the closing elements 3, namely in the influence region of the grease lubrication for the rollers 5, remains retained.

The invention has been described heretofore on the basis of at least one possible exemplary embodiment. It is understood that numerous modifications and derivations are possible without thereby departing from the inventive thinking underlying the invention.

The present invention is accordingly provided to catch lubricant, used on the lifting cam 4 for improving the rolling run of a roller 5, 5′, before it can penetrate into the hygiene area of the device, or even to the container mouth of the container. This is presented in detail in the description.

Provision is likewise made according to the invention, however, for the shell-shaped collecting device also to be provided so as to catch other lubricants which are encountered in the closing device and may drip. By way of example, also for catching lubricants which are used for the lubrication of pressure springs of the actual closing mechanism.

The following is at least a partial list of components shown in the figures and their related reference numerals: closing device 1; rotor 2; closing element 3; outer circumference 3.1; lifting cam 4; guide surface of the lifting cam 4a; outer circumference of the lifting cam 4.1; roller 5, 5′; running surface of the roller 5a; collecting device 6, 6′; securing section 7, 7′; base surface 8; side wall 9; catchment space 10; gripping element 11; container 20; container closing positions BP, BP′; middle axis MA; closing element axis VA; and plane E.

At least one possible exemplary embodiment of the present application relates to a rotary-type closing device 1 for the closing of containers 20, comprising a plurality of container closing positions BP, BP′ arranged at the circumference of a rotor 2 which is driven by a motor such as to rotate about a vertical middle axis MA of the closing device 1, with in each case at least one closing element 3, wherein, for the controlling of the height, the closing elements 3 are force-guided by means of a lifting cam 4 so as to rotate about the middle axis MA, wherein, at least at one of the plurality of closing elements 3, at least one shell-shaped collecting device 6, 6′ is provided, which is configured so as to catch lubricant used on the lifting cam 4 for the rolling running of a roller 5, 5′, in that the at least one collecting device 6, 6′ is provided with at least one securing section 7, 7′ at least partially circumferentially at least at one outer circumference 3.1 of the at least one closing element 3, as well as underneath the rollers 5, 5′.

At least one other possible exemplary embodiment of the present application relates to the rotary-type closing device 1, wherein the at least one shell-shaped collecting device 6, 6′ comprises a base surface 8 as well as side surfaces 9 surrounding the base surface 8 on the edge sides, such that inside the base surface 8 a shell-shaped catchment space 10 for the lubricant is formed, which is delimited on the sides by the side surfaces 9.

At least one other possible exemplary embodiment of the present application relates to the rotary-type closing device 1, wherein the base surface 8 is configured with the associated side surfaces 9 as being one unit, in particular as being of one piece, and is made of a plastic, in particular polyamide, or a metallic material, in particular special steel.

At least one other possible exemplary embodiment of the present application relates to the rotary-type closing device 1, wherein a plurality of closing elements 3, preferably all the closing elements 3, are equipped with at least one collecting device 6, 6′, wherein the closing elements 3 equipped with the collecting devices 6, 6′ are assigned to respective container closing positions BP, BP′, which are uniformly distributed over the circumference of the rotor 2.

At least one other possible exemplary embodiment of the present application relates to the rotary-type closing device 1, wherein at least one closing element 3 comprises several collecting devices 6, 6′ provided offset along the closing element axis VA and arranged at a distance interval from one another.

At least one other possible exemplary embodiment of the present application relates to the rotary-type closing device 1, wherein the plurality of collecting devices 6, 6′ are in each case configured as identical to one another.

At least one other possible exemplary embodiment of the present application relates to the rotary-type closing device 1, wherein the at least one collecting device 6 comprises a securing section 7, which is configured as a passage opening in the base surface 8 in full circumference matching the outer circumference 3.1 of the associated closing element 3.

At least one other possible exemplary embodiment of the present application relates to the rotary-type closing device 1, wherein the securing section 7 is configured as a circular passage opening in full circumference matching the outer circumference 3.1, which surrounds the outer circumference 3.1 in contact fit, in particular in non-positive and/or positive fit, in such a way that the collecting device 6 is held in a fixed position at the closing element 3.

At least one other possible exemplary embodiment of the present application relates to the rotary-type closing device 1, wherein the securing section 7 comprises at its circular free edge section, facing towards the associated closing element axis VA, at least partially circumferentially, a sealing element, or, as an alternative, is made of a sealing material.

At least one other possible exemplary embodiment of the present application relates to the rotary-type closing device 1, wherein the at least one collecting device 6′ comprises two securing sections 7′, which in each case are provided, in particular arranged, partially circumferentially at the respective outer circumference 3.1 between two adjacent closing elements 3 as well as underneath the rollers 5, 5′.

At least one other possible exemplary embodiment of the present application relates to the rotary-type closing device 1, wherein the two securing sections 7′ are formed at two opposing side surfaces 9 of the collecting device 6′, wherein these two side surfaces 9 are matched, at least in one part section, to the outer circumference 3.1 of the closing element 3.

At least one other possible exemplary embodiment of the present application relates to the rotary-type closing device 1, wherein the collecting device 6′ comprises a gripping element 11 on the side surface 9 facing away from the machine axis MA.

At least one other possible exemplary embodiment of the present application relates to the rotary-type closing device 1, wherein the two side surfaces 9 configured as securing sections 7′ form, at least in sections, in each case a partially circular section 7′, by means of which the collecting device 6′ is held between the respective outer circumferences 3.1 of two adjacent closing elements 3, in each case partially circumferentially and by fixed in place by contact fit, in particular in non-positive and/or positive fit, between the adjacent closing elements 3.

At least one other possible exemplary embodiment of the present application relates to the rotary-type closing device 1, wherein, between several adjacent closing elements 3, and preferably between all the adjacent closing elements 3, at least one collecting device 6′ is provided, wherein the closing elements 3 equipped with the collecting devices 6′ are assigned to respective container closing positions BP, BP′, which are arranged distributed uniformly over the circumference of the rotor 2.

At least one other possible exemplary embodiment of the present application relates to the rotary-type closing device 1, wherein the closing device 1 is a crown-cork fitter.

At least one possible exemplary embodiment of the present application relates to a closing element 3 for a rotary-type closing device 1 for closing containers 20, which closing device 1 comprises a plurality of container closing positions BP, BP′ arranged at the circumference of a rotor 2 driven by a motor such as to circulate about a middle axis MA, and a lifting cam 4 for controlling the height of the closing elements 3, wherein at least one shell-shaped collecting device 6, 6′ is provided at the closing element 3, which is formed such as to catch lubricant used on the lifting cam 4 for the rolling run of rollers, in that the at least one collecting device 6, 6′ is provided with at least one securing section 7, 7′ at least partially circumferentially at least at one outer circumference 3.1 of the at least one closing element 3, as well as underneath the rollers 5, 5′.

At least one possible exemplary embodiment of the present application relates to a method for closing containers 20, wherein the containers 20 are closed with closure covers, and specifically by means of a rotary-type closing device 1, comprising a plurality of container closing positions BP, BP′ arranged at the circumference of a rotor 2, driven by a motor such as to circulate about a vertical middle axis MA, with in each case at least one closing element 3, and with a lifting cam 4 for controlling the height of the closing elements 3, wherein at least at one of the plurality of closing elements 3 at least one shell-shaped collecting device 6, 6′ is provided, by means of which, in particular, lubricant is caught which is used on the lifting cam 4 for the rolling running of rollers, in that the at least one collecting device 6, 6′ is provided with at least one securing section 7,7′, at least partially circumferentially, at least at one outer circumference 3.1 of the at least one closing element 3, as well as underneath the rollers 5, 5′.

At least one possible exemplary embodiment of the present application relates to a rotary container closing device configured to close containers comprising beverage bottles or similar containers filled with a liquid beverage or liquid filling material, said container closing device comprising: a rotor having a vertical axis of rotation; closing elements being disposed at closing positions about the circumference of said rotor; said closing elements being configured to apply closures to filled containers supported at said closing positions; said rotor being configured and disposed to be rotated about the vertical axis of rotation to move said closing elements and filled containers; each of said closing elements comprising at least one roller; a cam guide arrangement being configured and disposed to engage with and guide said at least one roller to guide said closing elements in a vertical movement to control the vertical position of said closing elements upon rotation of said rotor; at least one collecting device being disposed at at least one of said closing elements; said at least one collecting device comprising at least one securing section configured to essentially conform to or essentially match at least a portion of a curved outer surface of a corresponding closing element to permit installation of said at least one collecting device at a corresponding closing position; and said at least one collecting device comprising a shell-like shape or basin-like shape and being disposed below said at least one roller to permit said at least one collecting device to catch and hold cam lubricant displaced out from between said cam guide arrangement and said at least one roller and into said at least one collecting device upon rotation of said rotor.

At least one other possible exemplary embodiment of the present application relates to the rotary container closing device, wherein said at least one collecting device comprises: a bottom surface; side surfaces disposed to extend from outer edges of said bottom surface and transverse to said bottom surface; and said bottom surface and said side surfaces together form said shell-like shape or basin-like shape configured to catch and hold cam lubricant.

At least one other possible exemplary embodiment of the present application relates to the rotary container closing device, wherein: said at least one securing section is configured to secure said at least one collecting device to a corresponding closing element; said at least one securing section comprises an opening in said bottom surface of said at least one collecting device; and said opening is configured to essentially match an outer circumference of a portion of its corresponding closing element.

At least one other possible exemplary embodiment of the present application relates to the rotary container closing device, wherein: said opening is circular and completely surrounds said portion of its corresponding closing element; and said opening is configured and disposed to contact said portion of its corresponding closing element such that said at least one collecting device is held in a fixed position at its corresponding closing element by at least one of a form fit and a friction fit.

At least one other possible exemplary embodiment of the present application relates to the rotary container closing device, wherein one of (A) and (B): (A) said at least one collecting device comprises a sealing element disposed on and to cover at least a portion of a circumferential edge of said opening; and (B) at least a portion of a circumferential edge of said opening comprises a sealing material.

At least one other possible exemplary embodiment of the present application relates to the rotary container closing device, wherein: said at least one collecting device comprises a plurality of collecting devices; and at least two of said collecting devices are disposed at one corresponding closing element, which said collecting devices are disposed at different positions and spaced apart from one another along a vertical axis of the one corresponding closing element.

At least one other possible exemplary embodiment of the present application relates to the rotary container closing device, wherein: said at least one collecting device comprises a plurality of collecting devices; and at least one of said plurality of collecting devices is disposed at each of said closing elements at each of said closing positions.

At least one other possible exemplary embodiment of the present application relates to the rotary container closing device, wherein: said bottom surface and said side surfaces are formed as an integral, one-piece structure comprising at least one of: a plastic, a polyamide, a metallic material, and a special steel; each of said plurality of collecting devices is essentially identical to one another; and said closing device is configured to apply crown corks or crown caps.

At least one other possible exemplary embodiment of the present application relates to the rotary container closing device, wherein: said at least one securing section comprises a first securing section and a second securing section; and said at least one collecting device is disposed between two adjacent closing elements, such that said first securing section is disposed immediately adjacent one of said two adjacent closing elements and said second securing section is disposed immediately adjacent the other of said two adjacent closing elements.

At least one other possible exemplary embodiment of the present application relates to the rotary container closing device, wherein: each of said first and second securing sections is formed by a portion of opposite side surfaces of said at least one collecting device; and each of said first and second securing sections is configured to essentially match a portion of an outer circumference of a portion of a corresponding closing element.

At least one other possible exemplary embodiment of the present application relates to the rotary container closing device, wherein each of said collecting devices comprises a gripping element disposed on a side surface to permit manual insertion and removal of said collecting devices into and out of an installed position between adjacent closing elements.

At least one other possible exemplary embodiment of the present application relates to the rotary container closing device, wherein: each of said first and second securing sections is curved to match a circular section of its corresponding closing element; and each of said first and second securing sections is disposed to contact said portion of its corresponding closing element such that said at least one collecting device is held in a fixed position between said two adjacent closing elements by a form fit and/or a friction fit.

At least one other possible exemplary embodiment of the present application relates to the rotary container closing device, wherein: said at least one collecting device comprises a plurality of collecting devices; and at least one of said collecting devices is disposed between each pair of adjacent closing elements.

At least one other possible exemplary embodiment of the present application relates to the rotary container closing device, wherein: said at least one collecting device comprises a plurality of collecting devices; and at least two of said collecting devices are disposed between one pair of adjacent closing elements, which said collecting devices are disposed at different positions and spaced apart from one another along a vertical axis of each of the adjacent closing elements.

At least one other possible exemplary embodiment of the present application relates to the rotary container closing device, wherein: said at least one collecting device comprises a plurality of collecting devices; and at least one of said collecting devices is disposed between each pair of adjacent closing elements.

At least one other possible exemplary embodiment of the present application relates to the rotary container closing device, wherein: said bottom surface and said side surfaces are formed as an integral, one-piece structure comprising at least one of: a plastic, a polyamide, a metallic material, and a special steel; each of said plurality of collecting devices is essentially identical to one another; and said closing device is configured to apply crown corks or crown caps.

At least one other possible exemplary embodiment of the present application relates to the rotary container closing device, wherein: said at least one collecting device comprises a plurality of collecting devices; and at least two of said collecting devices are disposed at one corresponding closing position, which said collecting devices are disposed at different positions and spaced apart from one another in a vertical direction.

At least one possible exemplary embodiment of the present application relates to a rotary container closing device closing element configured to close containers in a rotary container closing device having a rotor configured to support and move closing elements, said closing element comprising: a closing portion being configured to apply closures to filled containers supported at a closing position of a rotary container closing device; at least one roller being configured to engage with and be guided in a vertical movement by a cam guide arrangement of a rotary container closing device upon movement of a rotor; at least one collecting device being detachably connected to said closing portion; said at least one collecting device comprising at least one securing section configured to essentially conform to or essentially match at least a portion of a curved outer surface of a corresponding closing element to permit installation of said at least one collecting device at a corresponding closing position; and said at least one collecting device comprising a shell-like shape or basin-like shape and being disposed below said at least one roller to permit said at least one collecting device to catch and hold cam lubricant displaced out from between a cam guide arrangement and said at least one roller and into said at least one collecting device upon rotation of a rotor.

At least one other possible exemplary embodiment of the present application relates to the rotary container closing device closing element, wherein: said at least one collecting device comprises: a bottom surface; side surfaces disposed to extend from outer edges of said bottom surface and transverse to said bottom surface; and said bottom surface and said side surfaces together form said shell-like shape or basin-like shape configured to catch and hold cam lubricant; said at least one securing section is configured to secure said at least one collecting device to a corresponding closing portion; said at least one securing section comprises an opening in said bottom surface of said at least one collecting device; and said opening is configured to essentially match an outer circumference of a portion of its corresponding closing portion.

At least one other possible exemplary embodiment of the present application relates to the rotary container closing device closing element, wherein: said at least one collecting device comprises: a bottom surface; side surfaces disposed to extend from outer edges of said bottom surface and transverse to said bottom surface; and said bottom surface and said side surfaces together form said shell-like shape or basin-like shape configured to catch and hold cam lubricant; said at least one securing section comprises a first securing section and a second securing section; and said at least one collecting device is configured to be disposed between two adjacent closing portions, such that said first securing section and said second securing section are in contact with different closing portions.

At least one other possible exemplary embodiment of the present application relates to the rotary container closing device closing element, wherein said at least one collecting device comprises at least two collecting devices disposed at different positions and spaced apart from one another on said closing portion.

At least one possible exemplary embodiment of the present application relates to a method of operating a rotary container closing device to close containers comprising beverage bottles or similar containers filled with a liquid beverage or liquid filling material, said container closing device comprising a rotor and closing elements being disposed at closing positions about the circumference of said rotor, said method comprising the steps of: rotating said rotor about a vertical axis of rotation to move said closing elements and filled containers; moving at least one roller of each of said closing elements and engaging said at least one roller with a cam arrangement; guiding said at least one roller with said cam arrangement and thereby moving said closing elements in a vertical movement; applying, with said closing elements, closures to filled containers supported at said closing positions; upon engagement of said cam guide arrangement and said at least one roller, displacing cam lubricant out from between said cam guide arrangement and said at least one roller; and catching and holding displaced cam lubricant in at least one collecting device disposed below said at least one roller and comprising a shell-like shape or basin-like shape and comprising at least one securing section configured to essentially conform to or essentially match at least a portion of a curved outer surface of a corresponding closing element.

Any numerical values disclosed herein, if any, should be understood as disclosing all approximate values within plus or minus ten percent of the numerical value. Any ranges of numerical values disclosed herein, if any, should be understood as disclosing all individual values within the range of values, including whole numbers, tenths of numbers, or hundredths of numbers.

The entirety of the appended drawings, including all dimensions, proportions, and/or shapes disclosed thereby or reasonably understood therefrom, are hereby incorporated by reference.

All of the patents, patent applications, patent publications, and other documents cited herein, are hereby incorporated by reference as if set forth in their entirety herein.

The corresponding foreign or international patent applications, as originally filed and as published, from which the present application claims the benefit of priority, are hereby incorporated by reference as if set forth in their entirety herein, as follows: PCT/EP2020/061585; WO2020/229144; and DE102019112250.3.

The following patents, patent applications, patent publications, and other documents cited in the corresponding foreign or international patent applications listed in the preceding paragraph are hereby incorporated by reference as if set forth in their entirety herein, as follows: DE102017105509A1, published Sep. 20, 2018; DE9302086U1, published Apr. 8, 1993; WO2010118806A2, published Oct. 21, 2010; DE102017112218B3, published Aug. 9, 2018; JP2003137392A, published May 14, 2003; and JPH1143195A, published Feb. 16, 1999. Some examples of closing machines with closure elements controlled by lifting cams, components of which may possibly be incorporated into or adapted for use in at least one possible exemplary embodiment of the present application, may possibly be found in DE102017105509A1 and WO2010118806A2.

Although the invention has been described in detail for the purpose of illustration of any embodiments disclosed herein, including the most practical or preferred embodiments at the time of filing of this application, it is to be understood that such detail is solely for that purpose and that the invention is not limited to such embodiments, but, on the contrary, is intended to cover modifications and equivalent arrangements that are within the spirit and scope of the present application, including the specification and the claims as originally filed, as amended, or as issued. For example, it is to be understood that the present invention contemplates that, to the extent possible, one or more features or components of any disclosed embodiment can be combined with one or more features or components of any other disclosed embodiment.

What is claimed is:

1. A rotary container closing device configured to close containers comprising beverage bottles or similar containers filled with a liquid beverage or liquid filling material, said container closing device comprising:
a rotor having a vertical axis of rotation;
closing elements being disposed at closing positions about the circumference of said rotor;
said closing elements being configured to apply closures to filled containers supported at said closing positions;
said rotor being configured and disposed to be rotated about the vertical axis of rotation to move said closing elements and filled containers;
each of said closing elements comprising at least one roller;
a cam guide arrangement being configured and disposed to engage with and guide said at least one roller to guide said closing elements in a vertical movement to control the vertical position of said closing elements upon rotation of said rotor;
at least one collecting device being disposed at at least one of said closing elements;
said at least one collecting device comprising at least one securing section configured to essentially conform to or essentially match at least a portion of a curved outer surface of a corresponding closing element to permit installation of said at least one collecting device at a corresponding closing position; and
said at least one collecting device comprising a shell-like shape or basin-like shape and being disposed below said at least one roller to permit said at least one collecting device to catch and hold cam lubricant displaced out from between said cam guide arrangement and said at least one roller and into said at least one collecting device upon rotation of said rotor.

2. The rotary container closing device according to claim 1, wherein said at least one collecting device comprises:
a bottom surface;
side surfaces disposed to extend from outer edges of said bottom surface and transverse to said bottom surface; and
said bottom surface and said side surfaces together form said shell-like shape or basin-like shape configured to catch and hold cam lubricant.

3. The rotary container closing device according to claim 2, wherein:
said at least one securing section is configured to secure said at least one collecting device to a corresponding closing element;
said at least one securing section comprises an opening in said bottom surface of said at least one collecting device; and
said opening is configured to essentially match an outer circumference of a portion of its corresponding closing element.

4. The rotary container closing device according to claim 3, wherein:
said opening is circular and completely surrounds said portion of its corresponding closing element; and
said opening is configured and disposed to contact said portion of its corresponding closing element such that said at least one collecting device is held in a fixed position at its corresponding closing element by at least one of a form fit and a friction fit.

5. The rotary container closing device according to claim 3, wherein one of (A) and (B):
(A) said at least one collecting device comprises a sealing element disposed on and to cover at least a portion of a circumferential edge of said opening; and
(B) at least a portion of a circumferential edge of said opening comprises a sealing material.

6. The rotary container closing device according to claim 3, wherein:
said at least one collecting device comprises a plurality of collecting devices; and
at least two of said collecting devices are disposed at one corresponding closing element, which said collecting devices are disposed at different positions and spaced apart from one another along a vertical axis of the one corresponding closing element.

7. The rotary container closing device according to claim 3, wherein:
said at least one collecting device comprises a plurality of collecting devices; and
at least one of said plurality of collecting devices is disposed at each of said closing elements at each of said closing positions.

8. The rotary container closing device according to claim 7, wherein:
said bottom surface and said side surfaces are formed as an integral, one-piece structure comprising at least one of: a plastic, a polyamide, a metallic material, and a special steel;
each of said plurality of collecting devices is essentially identical to one another; and
said closing device is configured to apply crown corks or crown caps.

9. The rotary container closing device according to claim 2, wherein:
said at least one securing section comprises a first securing section and a second securing section; and
said at least one collecting device is disposed between two adjacent closing elements, such that said first securing section is disposed immediately adjacent one of said two adjacent closing elements and said second securing section is disposed immediately adjacent the other of said two adjacent closing elements.

10. The rotary container closing device according to claim 9, wherein:
each of said first and second securing sections is formed by a portion of opposite side surfaces of said at least one collecting device; and
each of said first and second securing sections is configured to essentially match a portion of an outer circumference of a portion of a corresponding closing element.

11. The rotary container closing device according to claim 10, wherein each of said collecting devices comprises a gripping element disposed on a side surface to permit manual insertion and removal of said collecting devices into and out of an installed position between adjacent closing elements.

12. The rotary container closing device according to claim 11, wherein:
each of said first and second securing sections is curved to match a circular section of its corresponding closing element; and
each of said first and second securing sections is disposed to contact said portion of its corresponding closing element such that said at least one collecting device is held in a fixed position between said two adjacent closing elements by a form fit and/or a friction fit.

13. The rotary container closing device according to claim 12, wherein:
said at least one collecting device comprises a plurality of collecting devices; and
at least one of said collecting devices is disposed between each pair of adjacent closing elements.

14. The rotary container closing device according to claim 9, wherein:
said at least one collecting device comprises a plurality of collecting devices; and
at least two of said collecting devices are disposed between one pair of adjacent closing elements, which said collecting devices are disposed at different positions and spaced apart from one another along a vertical axis of each of the adjacent closing elements.

15. The rotary container closing device according to claim 9, wherein:
said at least one collecting device comprises a plurality of collecting devices; and
at least one of said collecting devices is disposed between each pair of adjacent closing elements.

16. The rotary container closing device according to claim 15, wherein:
said bottom surface and said side surfaces are formed as an integral, one-piece structure comprising at least one of: a plastic, a polyamide, a metallic material, and a special steel;
each of said plurality of collecting devices is essentially identical to one another; and
said closing device is configured to apply crown corks or crown caps.

17. The rotary container closing device according to claim 2, wherein:
said at least one collecting device comprises a plurality of collecting devices; and
at least two of said collecting devices are disposed at one corresponding closing position, which said collecting devices are disposed at different positions and spaced apart from one another in a vertical direction.

18. A rotary container closing device closing element configured to close containers in a rotary container closing device having a rotor configured to support and move closing elements, said closing element comprising:
a closing portion being configured to apply closures to filled containers supported at a closing position of a rotary container closing device;
at least one roller being configured to engage with and be guided in a vertical movement by a cam guide arrangement of a rotary container closing device upon movement of a rotor;
at least one collecting device being detachably connected to said closing portion;
said at least one collecting device comprising at least one securing section configured to essentially conform to or essentially match at least a portion of a curved outer surface of a corresponding closing element to permit installation of said at least one collecting device at a corresponding closing position; and
said at least one collecting device comprising a shell-like shape or basin-like shape and being disposed below said at least one roller to permit said at least one collecting device to catch and hold cam lubricant displaced out from between a cam guide arrangement and said at least one roller and into said at least one collecting device upon rotation of a rotor.

19. The rotary container closing device closing element according to claim 18, wherein:
said at least one collecting device comprises:
a bottom surface;
side surfaces disposed to extend from outer edges of said bottom surface and transverse to said bottom surface; and
said bottom surface and said side surfaces together form said shell-like shape or basin-like shape configured to catch and hold cam lubricant;
said at least one securing section is configured to secure said at least one collecting device to a corresponding closing portion;
said at least one securing section comprises an opening in said bottom surface of said at least one collecting device; and
said opening is configured to essentially match an outer circumference of a portion of its corresponding closing portion.

20. The rotary container closing device closing element according to claim 18, wherein:
said at least one collecting device comprises:
a bottom surface;
side surfaces disposed to extend from outer edges of said bottom surface and transverse to said bottom surface; and
said bottom surface and said side surfaces together form said shell-like shape or basin-like shape configured to catch and hold cam lubricant;
said at least one securing section comprises a first securing section and a second securing section; and
said at least one collecting device is configured to be disposed between two adjacent closing portions, such that said first securing section and said second securing section are in contact with different closing portions.

21. The rotary container closing device according to claim 18, wherein said at least one collecting device comprises at least two collecting devices disposed at different positions and spaced apart from one another on said closing portion.

22. A method of operating a rotary container closing device to close containers comprising beverage bottles or similar containers filled with a liquid beverage or liquid filling material, said container closing device comprising a rotor and closing elements being disposed at closing positions about the circumference of said rotor, said method comprising the steps of:
rotating said rotor about a vertical axis of rotation to move said closing elements and filled containers;
moving at least one roller of each of said closing elements and engaging said at least one roller with a cam arrangement;
guiding said at least one roller with said cam arrangement and thereby moving said closing elements in a vertical movement;
applying, with said closing elements, closures to filled containers supported at said closing positions;
upon engagement of said cam guide arrangement and said at least one roller, displacing cam lubricant out from between said cam guide arrangement and said at least one roller; and
catching and holding displaced cam lubricant in at least one collecting device disposed below said at least one roller and comprising a shell-like shape or basin-like shape and comprising at least one securing section configured to essentially conform to or essentially match at least a portion of a curved outer surface of a corresponding closing element.
